(19) United States
(12) Patent Application Publication
(10) Pub. No.: US 2007/0008463 A1
(43) Pub. Date: Jan. 11, 2007

(54) Liquid crystal display device and electronic apparatus

(75) Inventors: Chihiro Tanaka, Matsumoto-shi (JP); Tomoaki Sekime, Shiojiri-shi (JP); Masahiro Horiguchi, Tottori-shi (JP); Kazu Kobayashi, Shiojirishi (JP)

Correspondence Address: OLIFF & BERRIDGE, PLC, P.O. BOX 19928, ALEXANDRIA, VA, 22320, US

(73) Assignee: SANYO EPSON IMAGING DEVICES CORPORATION, Tokyo (JP)

(21) Appl. No.: 11/480,836

(22) Filed: Jul. 6, 2006

(30) Foreign Application Priority Data
Jul. 6, 2005 (JP) 2005-197073(P)
Jun. 13, 2006 (JP) 2006-163117(P)

(51) Int. Cl. G02F 1/1335

(52) U.S. Cl. 349/107

(57) ABSTRACT

A liquid crystal display device includes a pair of substrates, a display pixel that has four R, G, B, and non-colored subpixels, and a liquid crystal layer that is interposed between the pair of substrates and in which cell thicknesses in the subpixels vary. The retardation values of the R, G, and B subpixels are set in the ranges of 360 nm≦R≦700 nm, 340 nm≦G≦600 nm, and 340 nm≦B≦500 nm, respectively, and the non-colored subpixel has a cell thickness at which the display pixel becomes predetermined white balance.

### BACKGROUND

1. Technical Field

The present invention relates to a liquid crystal display device which is suitable for displaying various information.

2. Related Art

Recently, a liquid crystal display device is used in portable equipment such as a mobile phone, a personal digital assistant and the like. In such a liquid crystal display device, one pixel is composed of subpixels, each having red (R), green (G), and blue (B) (hereinafter, simply referred to as ‘R’, ‘G’, and ‘B’) color filters. In such a liquid crystal display device, the optimal value of the retardation value represented by a product of birefractive index of liquid crystal and cell thickness differs in each subpixel. Therefore, in order to adjust white balance in halftone display, it is ideal to adjust a cell thickness for each subpixel.

Recently, there has been proposed a liquid crystal display device which further uses a transparent (W) (hereinafter, simply referred to as ‘W’) subpixel, in addition to three R, G, and B subpixels (for example, refer to JP-A-2004-004822).

In the liquid crystal display device described in JP-A-2004-004822, the cell thicknesses in four R, G, B, and W subpixels need to be adjusted, in order to perform such white balance adjustment.

### SUMMARY

An advantage of some aspects of the present invention is that it provides a liquid crystal display device which has a transparent (W) subpixel to perform adjustment of white balance.

According to an aspect of the invention, a liquid crystal display device includes a pair of substrates, a display pixel that has four R, G, B, and non-colored subpixels, and a liquid crystal layer that is interposed between the pair of substrates and in which cell thicknesses in the subpixels vary. The retardation values of the R, G, and B subpixels are set in the ranges of 360 nm≦R≦700 nm, 340 nm≦G≦600 nm, and 340 nm≦B≦500 nm, respectively, and the non-colored subpixel has a cell thickness at which the display pixel becomes predetermined white balance.

The above-described liquid crystal display device has the pair of substrates interposing the liquid crystal layer, cell thicknesses of a portion of the liquid crystal layer that corresponds to the individual subpixels being different from each other. One display pixel is composed of four R, G, B, and non-colored subpixels. The retardation values of the R, G, and B subpixels are set in the ranges of 360 nm≦R≦700 nm, 340 nm≦G≦600 nm, and 340 nm≦B≦500 nm, and the non-colored subpixel has a cell thickness where the display pixel is adjusted to predetermined white balance. As such, in the liquid crystal display device, the cell thickness of the non-color transparent subpixel can be set to a value where the display pixel is set to predetermined white balance, that is, the non-colored subpixel is set to predetermined chromaticity. Further, desired white display can be realized by a user.

In the liquid crystal display device according to the aspect of the invention, the cell thickness of the non-colored subpixel may be set to be substantially equal to the cell thickness of a one-color subpixel among the R, G, and B subpixels, in which the area occupied in the display pixel is the smallest. Even in this case, the non-colored subpixel can compensate light of color where the area occupied in the display pixel is the smallest, and it is possible to suppress coloring in white display.

In the liquid crystal display device according to the aspect of the invention, the display pixel may be configured such that the sum area of the non-colored subpixel and a one-color subpixel among the R, G, and B subpixels are substantially equal to an area of each of the other-color subpixels, and the cell thickness of the non-colored subpixel is set to a value at which the retardation value of the one-color subpixel and the retardation value of the non-colored subpixel become equal to each other. For example, when the summed area of the non-colored subpixel and the B subpixel among the R, G, and B subpixels are set to be substantially equal to each area of the other-color subpixels, and if white display is performed, the light emitted from the B subpixel is insufficient in comparison with the light emitted from the other-color subpixels. In the invention, however, the cell thickness of the non-colored subpixel is set to a value where the retardation value of the one-color subpixel and the retardation value of the non-colored subpixel are equal to each other. Accordingly, the light emitted from the W subpixel can compensate for the lack of B (blue) light, because B (blue) color component is emphasized. Further, it is possible to suppress the above-described coloring in white display which occurs because the area of the B subpixel is small.

In the liquid crystal display device according to the aspect of the invention, the display pixel may be configured such that the area ratio of the R, G, B, and non-colored subpixels is set to 2:2:1:1, and the cell thickness of the non-colored subpixel is set to be substantially equal to the cell thickness of the B subpixel. Then, the non-colored subpixel can compensate for the B light where the area occupied in the display pixel is the smallest.

In the liquid crystal display device according to the aspect of the invention, the display pixel may be configured such that the areas of four subpixels are substantially equal to each other, and the cell thickness of the non-colored subpixel is set to a value at which the retardation value of the G subpixel and the retardation value of the non-colored subpixel become equal to each other. Further, in a still further mode of the liquid crystal display device, the cell thickness of the non-colored subpixel is set to be substantially equal to the cell thickness of the G subpixel. In accordance with the construction, the retardation value of the non-colored subpixel substantially coincides with the retardation value of the G subpixel where the visibility is the highest. Therefore, it is possible to perform display with high luminance.

According to another aspect of the invention, a liquid crystal display device includes a pair of substrates, a display pixel that has four R, G, B, and non-colored subpixels and is configured such that the area ratio of the R, G, B, and non-colored subpixels is set to 2:2:1:1, and a liquid crystal layer that is interposed between the pair of substrates and in which cell thicknesses in the subpixels vary. If the cell thicknesses are set to dr, dg, db, and dw, the R, G, B, and non-colored subpixels have the relationship dr≧dg≧dw≈db (however, the relationship dr=dw=db is not established).

If white display is performed in the above-described construction, the light emitted from the B subpixel is insufficient in comparison with the light emitted from the other-color, that is, R and G subpixels. However, as the cell thickness of the non-colored subpixel is set to be substantially equal to the cell thickness of the B subpixel, the retardation values in these subpixels are substantially equal to each other. The light emitted from the non-colored subpixel can compensate for the lack of the B light, because the B component is emphasized. Accordingly, it is possible to suppress the above-described coloring in white display which occurs because the area of the B subpixel is small. That is, the non-colored subpixel can compensate for the light emitted from the B subpixel where the area occupied in the display pixel is the smallest.

According to another aspect of the invention, a liquid crystal display device includes a pair of substrate, a display pixel that has four R, G, B, and non-colored subpixels, and a liquid crystal layer that is interposed between the pair of substrates and in which cell thicknesses in the subpixels vary. If the cell thicknesses are set to dr, dg, db, and dw, the R, G, B, and non-colored subpixels have the relationship dr≧dw≈dg≧db (however, the relationship dr=dw=db is not established). In this case, the display pixel is configured so that the area ratio among the R, G, B, and non-colored subpixels is set to 1:1:1:1.

The above-described liquid crystal display device is composed of the pair of substrate interposing the liquid crystal layer, in which the cell thicknesses in the subpixels differ from each other. One display pixel is composed of four R, G, B, and non-colored subpixels. If the cell thicknesses are set to dr, dg, db, and dw, the R, G, B, and non-colored subpixels have a relationship of dr≧dw≈dg≧db (however, a relationship of dr=dw=db is not established). As such, the cell thicknesses substantially coincide with the cell thickness of the G subpixel where the visibility is the highest. Therefore, it is possible to perform display with high luminance. Such a construction is suitable when the areas of the R, G, and B subpixels are equal to each other and coloring of white display caused by the area ratio occurs.

According to another aspect of the invention, an electronic apparatus includes the above-described liquid crystal display device as a display unit.

### BRIEF DESCRIPTION OF THE DRAWINGS

The invention will be described with reference to the accompanying drawings, wherein like numbers reference like elements.

FIG. 1 is a cross-sectional view showing the construction of a liquid crystal display device.

FIG. 2 is a plan view showing the construction of the liquid crystal display device.

FIG. 3 is a diagram showing an example of the pixel arrangement structure of display pixels.

FIG. 4A is an enlarged plan view partially showing the construction of an element substrate.

FIG. 4B is an enlarged plan view partially showing the construction of a color filter substrate.

FIG. 5A is a cross-sectional view taken along the line VA-VA of FIGS. 4A and 4B.

FIG. 5B is a cross-sectional view taken along the line VB-VB of FIGS. 4A and 4B.

FIG. 6 is a graph showing the relationship between an applied voltage and transmittance in a general liquid crystal display device.

FIG. 7 is a plan view showing the construction of a liquid crystal display device.

FIG. 8 is a diagram showing an example of the pixel arrangement structure of a display pixel.

FIG. 9 is a diagram showing an effect of white balance adjustment.

FIG. 10 is a diagram showing examples of an electronic apparatus to which the liquid crystal display device according to embodiments of the invention is applied.

### DESCRIPTION OF EXEMPLARY EMBODIMENTS

Hereinafter, preferred embodiments of the present invention will be described with reference to the drawings. Moreover, the following embodiments of the present invention are applied to a liquid crystal display device.

### First Embodiment

(Schematic Construction of Liquid Crystal Display Device)

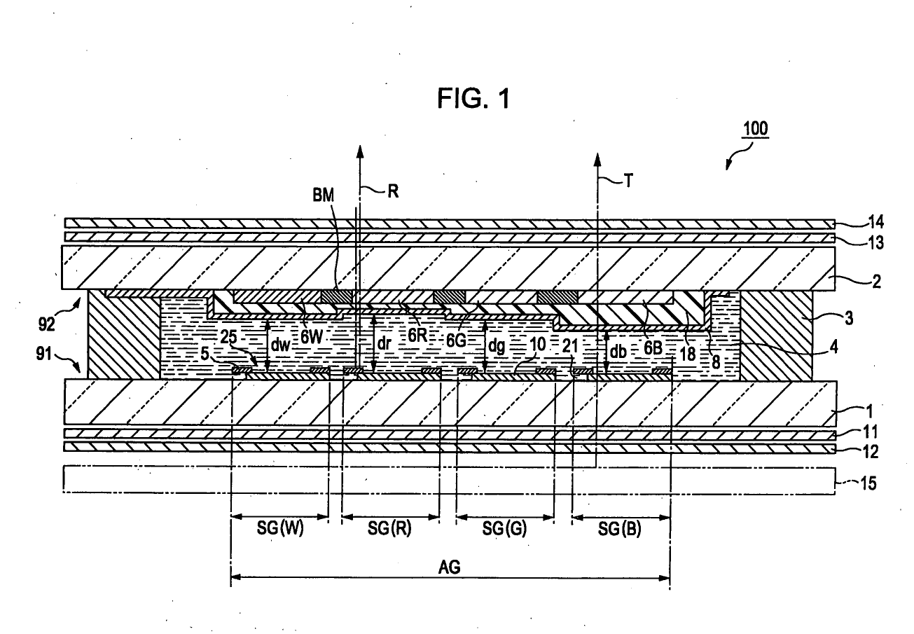

First, the construction of a liquid crystal display device according to a first embodiment of the invention will be described with reference to FIG. 1.

FIG. 1 is a cross-sectional view illustrating the construction of a liquid crystal display device 100 according to the present embodiment. More specifically, FIG. 1 is a cross-sectional view showing that R, G, B, and W (non-color) subpixels SG included in a display pixel AG are extracted and arranged, in order to explain the schematic construction of the liquid crystal display device 100.

In FIG. 1, the liquid crystal display device 100 is provided with an element substrate 91 and a color filter substrate 92 which is disposed to face the element substrate 91. The element substrate 91 and the color filter substrate 92 are bonded to each other through a frame-shaped seal member 3. Inside the liquid crystal display device 100, liquid crystal is sealed, thereby forming a liquid crystal layer 4.

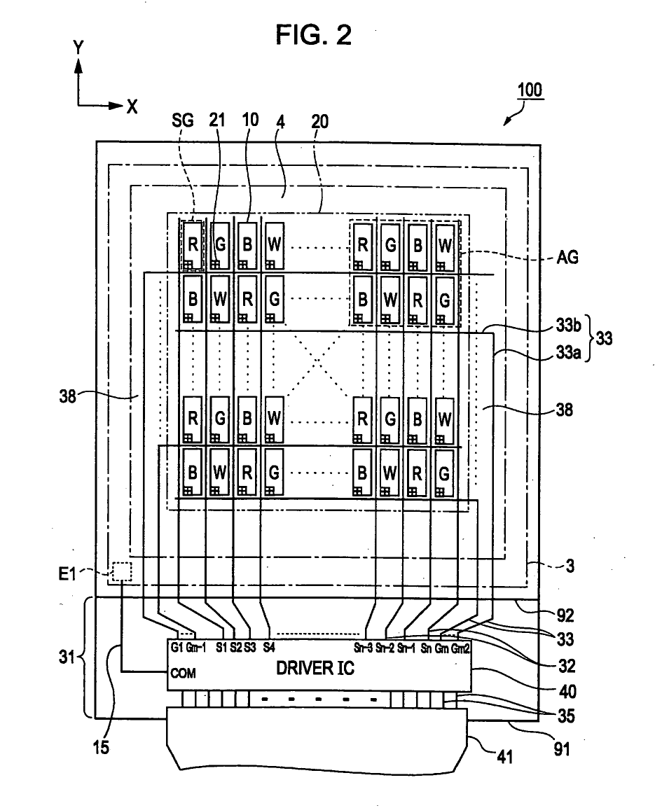

First, the element substrate 91 will be described. The element substrate 91 has a transparent lower substrate 1 such as glass. On the inner surface of the lower substrate 1, a plurality of data lines 32 and a plurality of scanning lines 33 (refer to FIG. 2) are disposed in a matrix. At the intersections of the data lines 32 and the scanning lines 33, the subpixels SG are provided. In each subpixel SG, a pixel electrode 10 is formed. Each pixel electrode 10 is connected to a TFT element 21 such as amorphous silicon TFT (Thin Film Transistor), and the data line 32 and the scanning line 33 are electrically connected to the TFT element 21 corresponding to each pixel electrode 10.

In each subpixel SG, a reflecting electrode 5 having a predetermined thickness is formed. The reflecting electrode 5 is electrically connected to the pixel electrode 10. The reflecting electrode 5 and the pixel electrode 10 are simultaneously driven. In each reflecting electrode 5, a plurality of rectangular apertures 25 are formed. Each reflecting electrode 5 can be formed of a thin film made of aluminum, aluminum alloy, silver alloy or the like. The apertures 25 are formed in the subpixels SG, that are disposed in a matrix within a pixel display region 20 (refer to FIG. 2), each aperture having a predetermined proportion of area with respect to the entire area of the corresponding subpixel SG. In the subpixel SG, portions corresponding to the apertures 25 are referred to as transmitting sections, and portions other than the portions corresponding to the apertures 25 are referred to as reflecting sections.

Next, the color filter 92 will be described. The color filter 92 has a transparent upper substrate 2 such as glass. On the inner surface of the upper substrate 2, any one of coloring layers 6R, 6G, 6B, and 6W, which are respectively composed of R, G, B, and W (non-color or white), is formed in each subpixel SG. The non-color (white) layer 6W is constructed by dispersing particles, of which the refractive index is different from that of a transparent resin, into a transparent resin layer or the transparent resin, in order to impart a light scattering (white) property. The coloring layers 6R, 6G, 6B, and 6W composes a color filter (hereinafter, simply referred to as ‘a coloring layer 6’, when colors are not distinguished). In FIG. 1, one display pixel AG shows one pixel region composed of R, G, B, and W subpixels SG.

In order to prevent light from being mixed from one subpixel SG into another subpixel SG, a black light shielding layer BM is formed between the coloring layers 6. The black light shielding layer BM can be formed by dispersing a black resin material such as black pigment into resin. On the inner surfaces of the substrate 2 and the coloring layers 6, an overcoat layer 18 made of transparent resin or the like is formed. The overcoat layer 18 has a function of protecting the coloring layers 6 from corrosion or contamination caused by chemicals used in manufacturing the color filer substrate 92. On the inner surface of the overcoat layer 18, a transparent common electrode 8 such as an ITO (Indium-Tin-Oxide) is formed.

As the thickness of the overcoat layer 18 is adjusted in each subpixel SG, the thickness of the liquid crystal layer 4, that is, the cell thickness of each subpixel SG is adjusted, as shown in FIG. 1. In FIG. 1, the R, G, B, and W subpixels SG have cell thicknesses dr, dg, db, and dw. When the data line 32 and the scanning line 33 simultaneously apply a voltage to the pixel electrode 10, the voltage is applied between the pixel electrode 10 and reflecting electrode 5 and the common electrode 8 by the TFT element 2, so that the liquid crystal of the liquid crystal layer 4 is aligned.

On the outer surface of the lower substrate 1, a retardation plate (quarter wavelength plate) 11 and a polarizing plate 12 are disposed. On the outer surface of the upper substrate 2, a retardation plate (quarter wavelength plate) 13 and a polarizing plate 14 are disposed. Further, in the lower side of the polarizing plate 12, an illuminating device 15 is disposed. Preferably, the illuminating device 15 is constructed by assembling a point light source such as LED (Light Emitting Diode), a linear light source such as a cold-cathode fluorescent tube, and a light guide plate.

When transmissive display is performed in the liquid crystal display device 100 of the present embodiment, the light emitted from the illuminating device 15 propagates along a path T shown in FIG. 1 and passes through the pixel electrode 10 and the coloring layer 6 so as to reach an observer. By applying a voltage between the pixel electrode 10 and the common electrode 8, the liquid crystal device 100 controls alignment of the liquid crystal of the liquid crystal layer 4 and changes light transmittance so as to perform a gray-scale display. Further, the light transmitted through the coloring layer 6 has predetermined color and brightness. As such, a desired color-display image is viewed by an observer.

Meanwhile, when reflective display is performed in the liquid crystal display device 100 of the present embodiment, external light incident on the liquid crystal display 100 propagates along a path R shown in FIG. 1. That is, the external light incident on the liquid crystal display device 100 passes through the coloring layer 6 and the liquid crystal layer 4, is reflected by the reflecting electrode 5, and again passes through the liquid crystal layer 4 and the coloring layer 6. Then, the light reaches an observer. By applying a voltage between the reflecting electrode 8 and the common electrode 8, the liquid crystal device 100 controls alignment of the liquid crystal of the liquid crystal layer 4 and changes light transmittance so as to perform a gray-scale display. Further, the external light passes through the region where the coloring layer 6 is formed, is reflected by the reflecting electrode 5, and again passes through the coloring layer 6, thereby having a predetermined color and brightness. As such, a desired color-display image is viewed by an observer.

(Detailed Construction of Liquid Crystal Display Device)

The construction of the liquid crystal display device 100 will be described in detail with reference to FIGS. 2 to 5.

FIG. 2 is a plan view schematically showing the construction of the liquid crystal display device 100. In FIG. 2, the color filter substrate 92 is disposed in the upper portion (observer side) of the drawing, and the element substrate 91 is disposed in the lower portion of the drawing. Each of the regions represented by R, G, B, and W indicates one subpixel SG. Moreover, the vertical direction (column direction) of the drawing is set to a Y direction, and the horizontal direction (row direction) of the drawing is set to an X direction.

The liquid crystal device 100 displays color images that are composed of four R (red), G (green), B (blue), and W (non-color or white) colors and is an active-matrix-type liquid crystal display device using the TFT element 21 serving as a switching element. Further, the liquid crystal display device 100 is a transflective liquid crystal display device having a transmission region and a reflection region within each of R, G, B, and W subpixels SG and is a liquid crystal display device having a multi-gap structure where the thickness of the liquid crystal layer 4 varies in the transmission region and the reflection region.

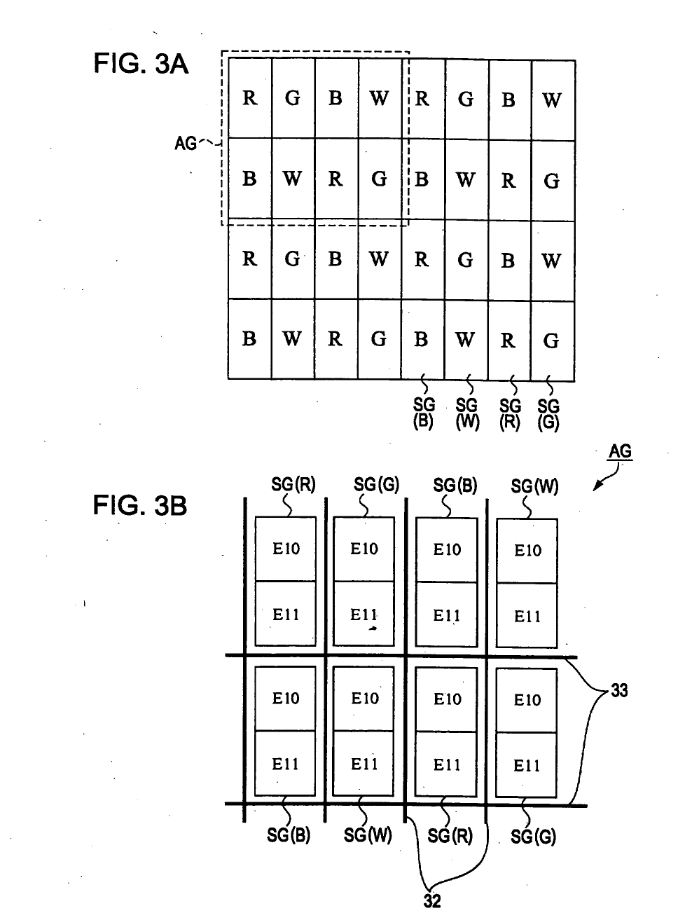

The arrangement structure of subpixels SG is shown in FIG. 3A. The subpixels SG are disposed in a matrix. Further, eight subpixels SG compose a substantially square display pixel AG. The display pixel AG itself is repeatedly disposed in a matrix. In other words, the subpixels SG are regularly arranged as the minimum unit of repetition of the display pixel AG.

Each display pixel AG is composed of 2×4 (two rows×four columns) subpixels SG. In every display pixel AG, the subpixels SG are arranged in the order of R, G, B, and W at the first row of the display pixel AG, and are arranged in the order of B, W, R, and G at the second row of thereof. Further, since two combinations of R, G, B, and W subpixels SG are incorporated in each display pixel AG, the areas of the subpixels SG are equal to each other in each display pixel AG. In other words, the area ratio among the R, G, B, and W subpixels within each display pixel AG is 1:1:1:1.

The display pixel AG in the liquid crystal display device 100 means the minimum unit of repetition for the arrangement of subpixels SG, but it doesn't mean the minimum unit of display.

The display pixel AG of the liquid crystal display device 100 is composed of R, G, B, and W, which is different from the related art where one display pixel is composed of R, G, and B. Further, the liquid crystal display device 100 performs display by using an image rendering technique which is different from the related art. Rendering is performed by using an image processing technique that applies a gray-scale signal supplied to subpixels provided with R, G, and B colors in one arbitrary display pixel AG, to subpixels with the same colors disposed in the vicinities of the display pixel AG, as well as the subpixels within the corresponding display pixel AG. That is, the R, G, and B subpixels SG in one display pixel AG perform display, by applying a gray-scale signal contributing to display of the subpixels within one display pixel AG also to the same colors of subpixels in the display pixel AG in the vicinity of one display pixel AG. Accordingly, the images can be viewed with the resolution which is higher than the number of actual pixels. For example, when a liquid crystal display device having a screen display resolution corresponding to the resolution of QVGA (Quarter Video Graphics Array) is used, a screen display resolution corresponding to the resolution of VGA (Video Graphics Array) is realized.

Returning to FIG. 2, the element substrate 91 has a protruding region 31 which protrudes outward from one side of the color filter substrate 92. On the protruding region 31, a driver IC 40, wiring lines 35 for external connection, an FPC (Flexible Printed Circuit) 41 and the like are formed or mounted. Input-side terminals (not shown) of the driver IC 40 are electrically connected to one ends of the wiring lines 35 for external connection, and the other ends of the wiring lines 35 for external connection are electrically connected to the FPC 41. The data lines 32 are formed so as to extend in the Y direction and to be spaced at a proper distance in the X direction, and one ends of the data lines 32 are electrically connected to output-side terminals (not shown) of the driver IC 40.

The scanning lines 33 are provided with first wiring lines 33a that extend in the Y direction and second wiring lines 33b that extend in the X direction from the end of the first wiring lines 33a. The second wiring lines 33b of the scanning lines 33 extend in a direction intersecting the data lines 32, that is, in the X direction and are spaced at a proper distance in the Y direction. One ends of the first wiring lines 33a of the scanning lines 33 are electrically connected to the output-side terminal (not shown) of the driver IC 40. In positions corresponding to the intersections of the data lines 32 and the second wiring lines 33b of the scanning lines 33, the TFT elements 21 are provided, which are electrically connected to the data lines 32, the scanning lines 33, the pixel electrodes 10 and the like. The TFT element 21 and the pixel electrode 10 are provided in a position corresponding to each sub pixel SG. The pixel electrode 10 is formed of a transparent conductive material such as an ITO (Indium-Tin Oxide).

The region, where the plurality of display pixels AG are arranged in a matrix in the X and Y directions, is a pixel display region 20 (surrounded by a two dot chain line). In the pixel display region 20, images such as characters, numbers, figures and the like are displayed. Further, the region outside the pixel display region 20 is set to a frame region 38 which does not contribute to display. On the inner surfaces of the data lines 32, the scanning lines 33, the TFT elements 21, and the pixel electrodes 10, an alignment film (not shown) is formed.

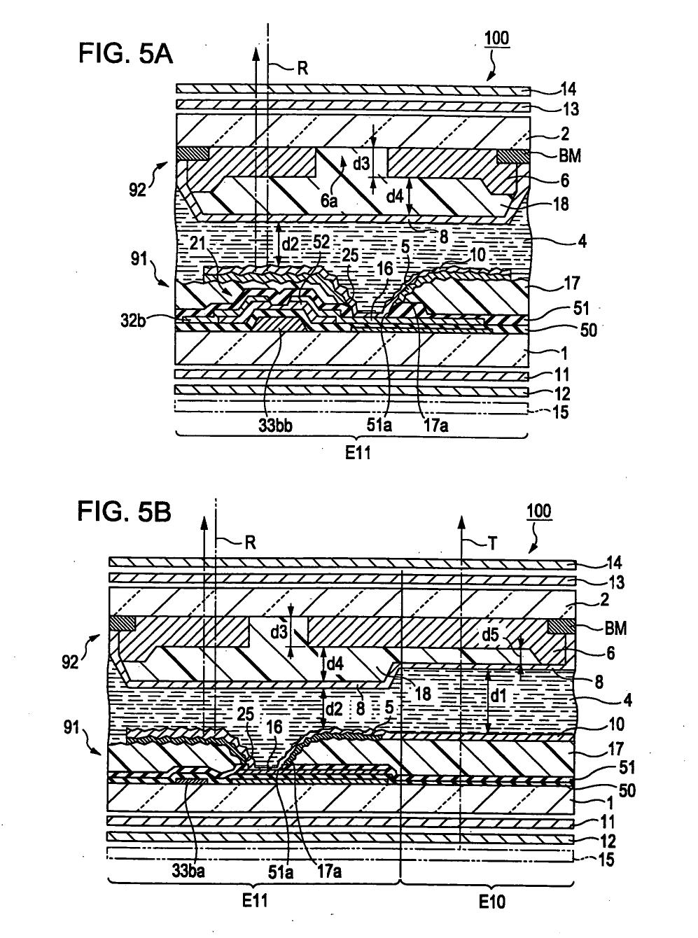

Meanwhile, on the inner surface of the color filter substrate 92, the common electrode 8 is formed (refer to FIGS. 1 and 5). Similar to the pixel electrode 10, the common electrode 8 is made of a transparent conductive material such as an ITO. The common electrode 8 is formed on almost one surface of the color filter substrate 92. The common electrode 8 is electrically connected to one end of the wiring lines 15 in a region E1 positioned in the corner of the seal member 3, and the other end of the wiring lines 15 is electrically connected to an output terminal corresponding to COM of the driver IC 40.

In the liquid crystal display device 100 having the above-described construction, the scanning lines 33 are exclusively selected one by one in the order of G1, G2, . . . , Gm-1, Gm (m is a natural number) by the driver IC 40, on the basis of the signal and electric power from the PFC 41 connected to an electronic apparatus and the like. Further, a gate signal of the selection voltage is supplied to the selected scanning lines 33, and a gate signal of a non-selection voltage is supplied to other scanning lines 32 which are not selected. The driver IC 40 supplies a source signal according to the display content to the pixel electrodes 10, which are present in the positions corresponding to the selected scanning lines 33, through the data lines 32 (S1, S2, . . . , Sn-1, Sn (n is a natural number)) corresponding thereto and the TFT elements 21. As a result, the alignment state of the liquid crystal 4 is controlled.

With reference to FIG. 3B, the construction of one display pixel AG will be described. FIG. 3B is an enlarged plan view showing a portion corresponding to one display pixel AG (a portion surrounded by a dashed line) in FIG. 2 or 3A. As shown in FIG. 3B, one display pixel AG is composed of 2×4 (two rows×four columns) subpixels SG corresponding to R, G, B, and W. Further, each of the subpixels corresponding to R, G, B, and W is provided with a transmission region E10, in which transmissive display is performed, and a reflection region E11 in which reflective display is performed.

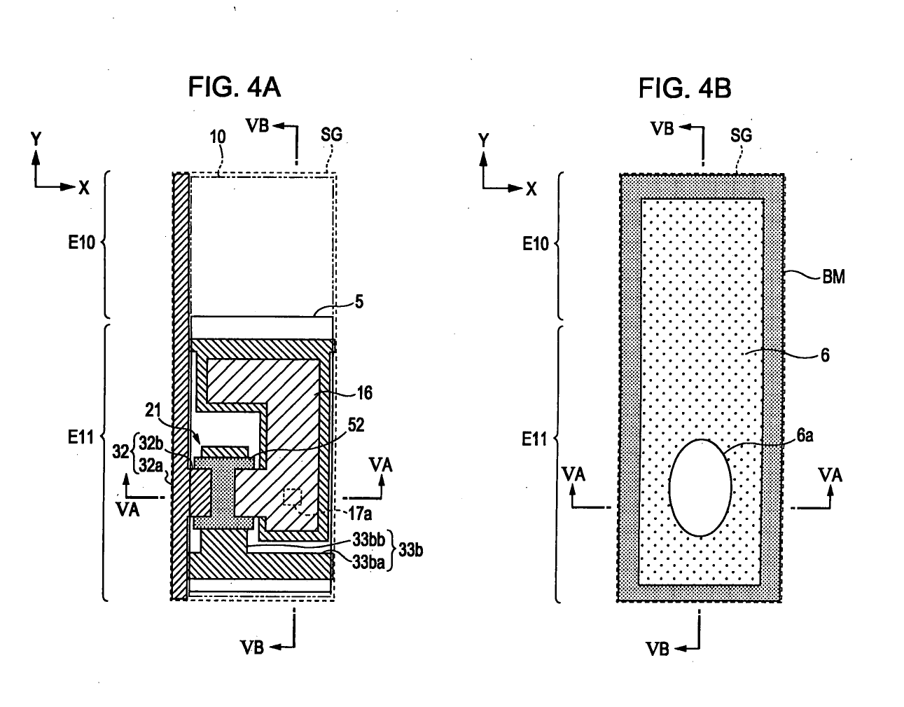

With reference to FIG. 4, each construction of the subpixels corresponding to R, G, B, and W in FIG. 3B will be described. In this case, the construction is divided into the reflection region E11 and the transmission region E10. FIG. 4A is an enlarged plan view partially showing the construction of the element substrate 91 corresponding to each of the R, G, B, and W subpixels SG. FIG. 4B is an enlarged plan view partially showing the construction of the color filter substrate 92 corresponding to each of the R, G, B, and W subpixels SG, the color filter substrate 92 being disposed to face the element substrate 91 of FIG. 4A. FIG. 5A is a partial cross-sectional view taken along the line VA-VA in FIGS. 4A and 4B, showing the cross-sectional construction of the liquid crystal display device 100 corresponding to each reflection region E11 of the R, G, B, and W subpixels SG. FIG. 5B is a partial cross-sectional view taken along the line VB-VB in FIGS. 4A and 4B, showing the cross-sectional construction of the liquid crystal display device 100 corresponding to each of the R, G, B, and w subpixels SG.

First, the construction of the reflection region E11 within one of R, G, B, and W subpixels will be described. As shown in FIG. 4A, the second wiring lines 33b of the scanning line 33 (refer to FIG. 2) have a main line portion 33ba extending in the X direction and a branch line portion 33bb branched from the main line portion 33ba so as to be curved in the Y direction. The scanning line 33 including these is disposed on the lower substrate 1, and the branch line portion 33bb is shown in FIG. 5A. On the lower substrate 1 and the scanning line 33, a gate insulating layer 50 having insulation properties is formed. On the gate insulating layer 50, and in a position which overlaps the branch line portion 33bb of the scanning line 33 in plan view, an a-Si layer 52 is provided which is a component of the TFT element 21. On the gate insulating layer 50, the data line 32 is formed so as to extend in the direction intersecting the scanning line 33.

As shown in FIG. 4A, the data line 32 has a main line portion 32a extending in the Y direction and a branch line portion 32b branched from the main line portion 32a so as to be curbed in the X direction. A portion of the branch line portion 32b of the data line 32 is formed on one end portion of the a-Si layer 52. On the other end portion of the a-Si layer 52 and the gate insulating layer 50, a storage capacitive electrode 16 made of metal or the like is formed. Therefore, the a-Si layer 52 is electrically connected to the data line 32 and the storage capacitive electrode 16, respectively. Further, in a position corresponding to the a-Si layer 52, the TFT element 52 including the layer as a component is formed.

On the data line 32, the storage capacitive electrode 16, and the gate insulating layer 50 and the like, a passivation layer (reaction preventing layer) 51 having insulation properties is formed. The passivation layer 51 has a contact hole (aperture) 51a formed in a position which overlaps the storage capacitive electrode 16 in plan view. On the passivation layer 51, a resin layer 17 made of resin is formed. On the surface of the rein layer 17, a plurality of minute irregularities are formed to have a function of scattering light. The resin layer 17 has a contact hole 17a formed in a position corresponding to the contact hole 51a of the passivation layer 51. On the resin layer 17, the reflecting electrode 5 is formed, which is made of Al (aluminum) or the like and has a reflecting function. Since the reflecting electrode 5 is formed on the resin layer 17 having the plurality of minute irregularities, the reflecting electrode 5 is formed in a shape which reflects the plurality of minute irregularities. In the position of the reflecting electrode 5 corresponding to the contact holes 51a and 17a, a transmission aperture region 25 is formed which transmits light. On the reflecting electrode 5 and the transmission aperture region 25, the pixel electrode 10 is formed.

Meanwhile, the construction of the color filter substrate 92 corresponding to the reflection region E11 within one of R, G, and B subpixels will be explained as follows.

On the upper substrate 2 made of the same material as the lower substrate 1, and in the position corresponding to the reflecting region E11, the R, G, and B coloring layers 6 are formed. The thickness of each coloring layer 6 is set to d3. The coloring layer 6 has an aperture 6a having a function of displaying a uniform color in the transmission region E10 and the reflection region E11. In a position partitioning the coloring layers 6 adjacent to each other, the black light shielding layer BM is formed. On the coloring layer 6, the overcoat layer 18 made of resin material is formed. The thickness of the overcoat layer 18 is set to d4. As the thickness d4 of the overcoat layer 18 is adjusted in each subpixel SG, the thickness (cell thickness) d2 of the liquid crystal layer 4 corresponding to each reflection region E11 of R, G, B, and W subpixels can be changed for each subpixel SG. On the overcoat layer 18, the common electrode 8 is formed.

The element substrate 91 corresponding to the above-described reflection region E11 and the color filter substrate 92 corresponding to the reflection region E11 are disposed to face each other, with the crystal layer 4 interposed therebetween. Further, the thickness of the liquid crystal layer 4 corresponding to the reflection region E11 is set to d2, as described above.

Next, the construction of the transmission region E10 within one of R, G, B, and W subpixels SG will be described.

On the lower substrate 1, the gate insulating layer 50 is formed, as shown in FIG. 5B. On the gate insulating layer 50, the passivation layer 51 is formed. On the passivation layer 51, the resin layer 17 is formed. As described above, while the resin layer 17 formed on the reflection region E11 has minute irregularities formed on the surface thereof, the resin layer 17 formed on the transmission region E10 does not have minute irregularities on the surface thereof. That is, the surface of the resin layer 17 formed on the transmission layer E10 is formed to be substantially flattened. On the resin layer 17, the pixel electrode 10 is formed.

The construction of the color filter substrate 92 corresponding to the transmission region E10 within one of R, G, B, and W subpixels will be described as follows. On the upper substrate 2, the coloring layers 6 are formed. On each coloring layer 6, the overcoat layer 18 with a thickness d5 is formed. As the thickness d5 of the overcoat layer 18 is adjusted, the thickness (cell thickness) d1 of the liquid crystal layer 4 corresponding to each transmission region E10 of R, G, B, and W subpixels can be changed for each subpixel SG. On the overcoat layer 18, the common electrode 8 is formed. On the outer surface of the upper substrate 2, the retardation plate 11 is disposed. On the outer surface of the retardation plate 11, the polarizing plate 12 is disposed.

The element substrate 91 corresponding to the above-described transmission region E10 and the color filter substrate 92 corresponding to the transmission region E10 are disposed to face each other, with the liquid crystal layer 4 interposed therebetween. In each subpixel SG, the thickness d5 of the overcoat layer 18 in the transmission region E10 is set to be different from the thickness d4 of the overcoat layer 18 in the reflection region E11. Accordingly, the thickness d1 of the liquid crystal layer 4 in the transmission region E10 is set to be larger than the thickness d2 of the liquid crystal layer 4 in the reflection region E11, which is referred to as a so-called multi-gap structure.

In addition, the thickness d1 of the liquid crystal layer 4 in the transmission region E10 has the values of dr, dg, db, and dw in R, G, B, and w subpixels SG, as described in FIG. 1. Similar to the thickness d1, the thickness d2 of the liquid crystal layer 4 in the reflection region E11 is set to have a value corresponding to each subpixel SG. Therefore, the cell thickness of the liquid crystal 4 is set to have eight different values at a maximum. Since the purpose of varying the thickness d2 in each subpixel is the same as the purpose on the thickness d1, only matters related to the thickness d1 (dr, dg, db, and dw) will be described in the present specification.

(Relationship between Cell Thickness and Transmittance)

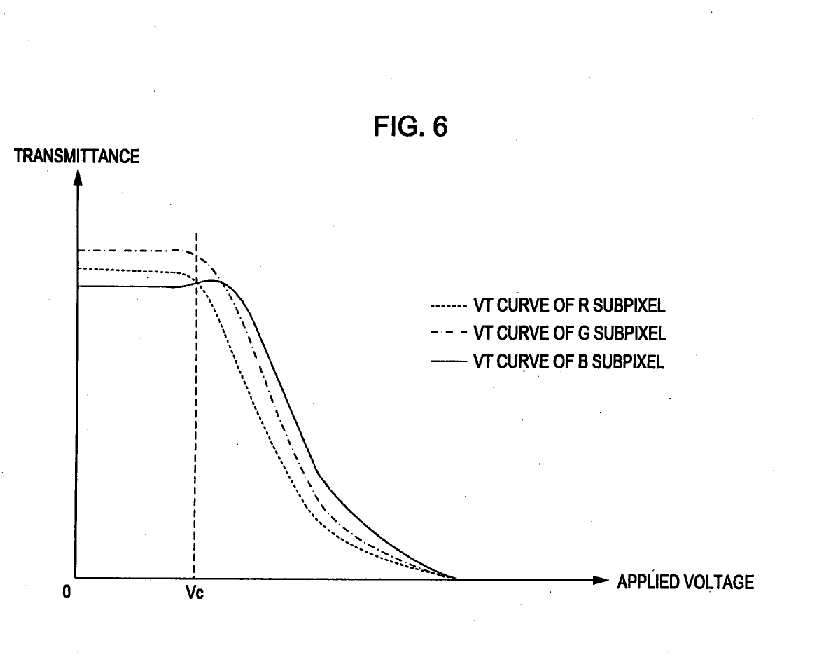

Next, the relationship between cell thickness and transmittance will be described. FIG. 6 is a graph showing the relationship between an applied voltage in each subpixel and transmittance in a general liquid crystal display device. The general liquid crystal display device is composed of R, G, and B subpixels and is a normally-white liquid crystal display device. In the general liquid crystal display device, the cell thicknesses in the R, G, and B subpixels are set to be the same as each other. Here, the horizontal axis indicates the magnitude of voltage applied between the pixel electrode 10 and the common electrode 8 in a subpixel, and the vertical axis indicates the transmittance of light in each of R, G, and B subpixels. The light transmittance of R, G, and B subpixels is determined by the alignment state of the liquid crystal of the liquid crystal layer 4.

In FIG. 6, if an applied voltage is increased, the light transmittances in the R. G, and B subpixels do not change until the voltage approaches a certain voltage Vc. However, when the applied voltage becomes larger than the voltage Vc, that is, when halftone display is performed, the alignment state of liquid crystal of the liquid crystal layer 4 changes, and the light transmittances in the R, G, and B subpixels accordingly change. When the applied voltage becomes larger than the voltage Vc, a curved line (hereinafter, referred to as ‘VT curve’) indicating the light transmittance in each subpixel declines steeply. That is, the light transmittance in each subpixel decreases. The declination characteristics of the VT curves in the subpixels are different from each other. A decrease in transmittance in the R subpixel is the largest, and a decrease in transmittance in the B subpixel is the smallest. Accordingly, when an applied voltage becomes larger than Vc, the transmittances of the subpixels are set in the order of the B subpixel, G subpixel, and R subpixel. Therefore, in the above-described general liquid crystal display device, when the cell thicknesses of the subpixels are equal to each other, and if all pixels are displayed with the same gray scale, bluish white display is performed at all times.

Although the horizontal axis is set to the magnitude of a voltage applied between the reflecting electrode 5 and common electrode 8 and the vertical axis is set to the light reflectance of a subpixel, the light reflectance of the subpixel is determined by the alignment state of the liquid crystal of the liquid crystal layer 4. Therefore, the relationship between the applied voltage and the reflectance is represented by a graph showing the same characteristic as FIG. 6. Even in this case, when an applied voltage becomes larger than Vc, the transmittances of the subpixels are set in the order of the B subpixel, G subpixel, and R subpixel. Therefore, when the cell thicknesses of the subpixels are equal to each other, and if all pixels are displayed with the same gray-scale, bluish white display is performed at all times.

In order to suppress such coloring, a retardation value Δn·d, which is defined by a product of the birefractive index Δn of the liquid crystal layer 4 and the cell thickness d, is set in the relationship of R≧G≧B in the liquid crystal display device 100. Specifically, if the wavelength of R light is set to λr (about 650 nm), the wavelength of G light is set to λg (about 550 nm), the wavelength of B light is set to λb (about 400 nm), the birefractive indexes of the liquid crystal 4 at λr, λg, and λb are respectively set to Δnr, Δng, and Δnb, and the cell thicknesses of R, G, and B subpixels SG are set to dr, dg, and db, the ratios of the retardation value to the wavelength of light (Δnr·dr/λr, Δng·dg/λg, and Δnb·db/λb) in the R, G, and B subpixels SG are set to the same value as each other. Here, the birefractive index Δn of the liquid crystal layer 4 differs according to the wavelength of transmitted light, but is substantially constant. Accordingly, the relationship between the cell thicknesses in the subpixels SG is established by dr≧dg≧db (however, the relationship of dr=dg=db is not established). The range of the retardation value of each subpixel is set in 360 nm≦R (=Δnr·dr)≦700 nm, 340 nm≦G (=Δng·dg)≦600 nm, and 340 nm≦B (=Δnb·db)≦500 nm.

As the cell thicknesses of the R, G, and B subpixels are set in such a manner, the lights emitted from the subpixels SG are strengthened by the interference therebetween when passing through the liquid crystal layer 4. Accordingly, in the liquid crystal display device 100 according to the present embodiment, the VT curves of the subpixels SG shown in FIG. 6 can be caused to coincide with each other. Further, even though the magnitude of the voltage applied to the subpixel SG is larger than the voltage Vc, it is possible to suppress coloring when white display is performed.

The liquid crystal display device 100 according to the present embodiment is further provided with the W subpixel SG. The retardation value Δnw·dw in the W subpixel SG is set between the wavelength λr of R light and the wavelength λb of B light. That is, the cell thickness dw in the W subpixel SG is set to a value where the relationship of dr≧dw≧db is established (however, the relationship of dr=dw=db is not established). If the retardation value Δnw·dw in the W subpixel SG is set to a value approximate to the wavelength λr of R light, the transmission efficiency of R light in the W subpixel SG increases when white display is performed. Then, reddish white display is performed. Similarly, if the retardation value Δnw·dw in the W subpixel SG is set to a value approximate to the wavelength λb of B light, the transmission efficiency of B light in the W subpixel SG increases when white display is performed. Then, bluish white display is performed. As such, when the retardation value Δnw·dw in the W subpixel SG is adjusted, that is, the cell thickness dw is adjusted, white balance can be set to predetermined color temperature, and desired white display can be realized by a user.

(Application of Adjustment of White Balance)

In the liquid crystal display device 100 of the present embodiment, the areas of the R, G, B, and W subpixels in the display pixel AG are equal to each other, as shown in FIG. 3A. In this case, a deviation in white balance caused by the area ratio among the R, G, and B subpixels does not occur. Therefore, when the retardation value Δnw·dw in the W subpixel SG is adjusted, the value does not need to be set to a value approximate to λr or λb to perform reddish or bluish white display. Therefore, the cell thickness dw of the W subpixel SG is set to a value approximate to the wavelength of G light where luminance with the highest visibility is easily secured, that is, a value where the relationship of dr≧dw≈dg≧db is established (however, the relationship of dr=dw=db is not established). Alternately, the retardation value Δnw·dw in the W subpixel SG is set to be equal to the retardation value Δng·dg in the G subpixel SG. According to such a construction, it is possible to perform display with high luminance.

Table 1 comparatively shows luminance when the cell thickness dw of the W subpixel SG is set to 2.6 μm or 3.0 μm, in a case where the cell thickness dg of the G subpixel Sg is constantly set to 3.0 μm in the liquid crystal display device 100. In accordance with this table, it is understood that the luminance of display increases if the cell thicknesses dw and dg are set to be equal to each other (that is, set to 3.0 μm).

TABLE 1

Cell thickness (μm)

| dw | dg | Luminance |
|---|---|---|
| 2.6 | 3.0 | 0.161 |
| 3.0 | 3.0 | 0.167 |

### Second Embodiment

Continuously, a liquid crystal display device 200 according to a second embodiment of the invention will be described. In the liquid crystal display device 200, the arrangement structure of subpixels SG in each display pixel AG is different from that of the liquid crystal display device 100 of the first embodiment. Since other constructions are the same as those of the liquid crystal display device 100, like reference numerals are attached to the same components as those of the liquid crystal display device 100, and the descriptions thereof will be omitted.

(Construction of Liquid Crystal Device)

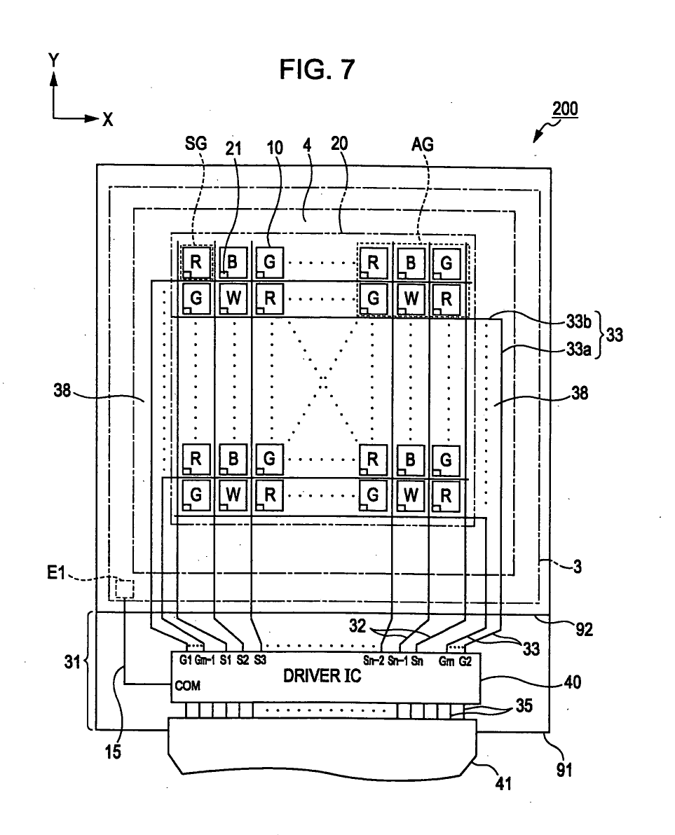

FIG. 7 is a plan view schematically showing the construction of the liquid crystal display device 200 according to the preset embodiment. The liquid crystal display device 200 is different from the liquid crystal display device 100 in that each display pixel AG is composed of 2×3 (two rows×three columns) subpixels SG.

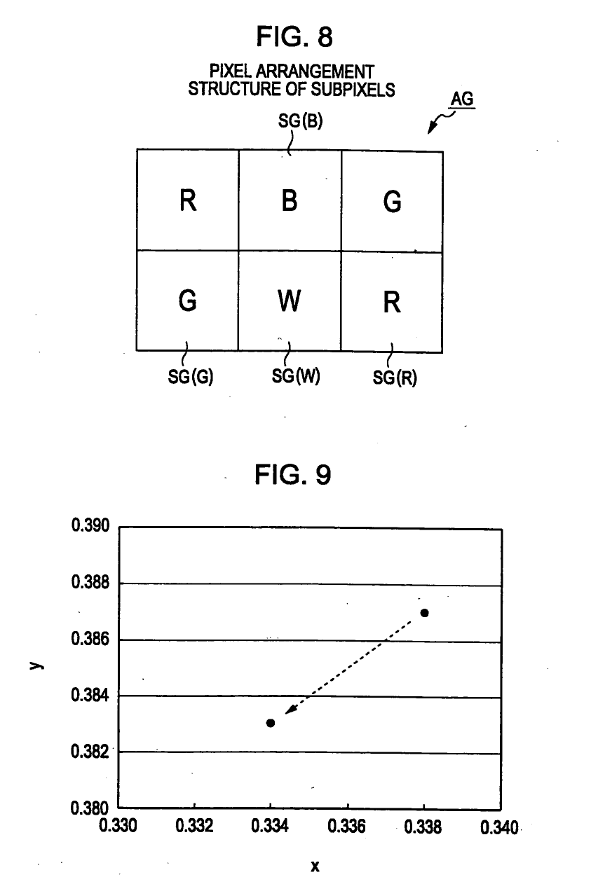

The arrangement structure of subpixels SG within the display pixel AG in the liquid crystal display device 200 is shown in FIG. 8. The display pixel AG has 2×3 (two rows×three columns) subpixels SG, composed of two R subpixels SG, two G subpixels SG, one B subpixel SG, and one W (non-color or white) subpixel SG. More specifically, the first row is arranged in the order of R, B, and G, and the second row is arranged is an order of G, W, and R. In a pixel display region 20 (refer to FIG. 7) of the liquid crystal display device 200, the above-described display pixel AG is repeatedly arranged in a matrix. Here, the display pixel AG in the liquid crystal display 200 means the minimum unit of repetition for the arrangement of subpixels SG but does not mean the minimum unit of display. The liquid crystal display device 200 performs display by using rendering, similar to the liquid crystal display device 100.

The reason why the number of B subpixels SG is smaller than the number of R or G subpixels is as follows. The B subpixel SG does not have much luminance information in comparison with the G or R subpixel, and can sufficiently adjust color balance. Therefore, as the B subpixel SG is replaced with the W subpixel SG, it is possible to significantly enhance luminance. As such, in the pixel arrangement structure of the display pixel AG, the R, G, and B subpixels are not equally disposed on the liquid crystal display, but the areas and arrangement of the R, G, and B subpixels SG are optimized in consideration of visual characteristics with respect to color. Therefore, in the liquid crystal display device 200 having the display pixel AG shown in FIG. 8, display with a high quality can be realized with a smaller number of subpixels than a general liquid crystal display device.

(Application of Adjustment of White Balance)

In the display pixel AG shown in FIG. 8, the number of B subpixels SG is smaller than the number of R or G subpixels SG. Therefore, the area of the B subpixel SG in the entire display pixel AG becomes smaller than that of the R or G subpixel SG. Specifically, the display pixel AG is configured so that the summed area of the B and W subpixels SG among the R, G, and B subpixels is substantially equal to each area of the other subpixels SG. In the display pixel AG shown in FIG. 8, the area ratio among the R, G, B, and W subpixels SG is set to 2:2:1:1. In the liquid crystal display device 200 having the display pixel AG with such a pixel arrangement structure, yellowish white display is performed when white display is performed, because the B light is insufficient. In the liquid crystal display 200 according to the present embodiment, the retardation value Δnw·dw in the W subpixel SG is set to a value approximate to the retardation value Δnb·nb in the B subpixel SG, in order to suppress such coloring in white display. That is, the cell thickness in the W subpixel SG is adjusted so as to substantially equal to the cell thickness of the B subpixel SG. Accordingly, the light emitted from the W subpixel SG can compensate for the lack of B light, because the B color component is emphasized. Further, it is possible to suppress the above-described coloring in white display which occurs because the area of the B subpixel SG is small. Then, as the cell thickness of the W subpixel SG is adjusted so as to emphasize the B light component, it is possible to compensate for the B color component in the display pixel AG and to suppress coloring in white display.

Table 2 shows chromaticity coordinates of white display when the cell thickness dw of the W subpixel SG is set to 3.0 μm or 2.6 μm, in a case where the cell thickness db of the B subpixel SG is constantly set to 2.6 μm in the liquid crystal display device 200. FIG. 9 shows that the chromaticity coordinates of Table 2 are plotted on x-y coordinates. It is understood from the table and figure that the chromaticity coordinates of white display approach a white spot (a dashed arrow in FIG. 9) when the cell thicknesses dw and db are set to be equal (2.6 μm) to each other.

TABLE 2

| | |
|---|---|
| | Chromaticity |
| Cell thickness (μm) | coordinates |

| dw | db | x | y |
|---|---|---|---|
| 3.0 | 2.6 | 0.338 | 0.387 |
| 2.6 | 2.6 | 0.334 | 0.383 |

In the application, it has been described that the area of the B subpixel SG is smaller than that of R or G subpixel SG. Without being limited to the B subpixel SG, however, the technique of the invention can be used even when the area of R or G subpixel SG is relatively small. At this time, the display pixel AG is configured so that the summed area of the W subpixel SG and one-color subpixel SG among R, G, and B subpixels is substantially equal to each area of the other subpixels SG. In this case, the cell thickness of the W subpixel SG is adjusted so that the cell thickness of the W subpixel SG is set to be substantially equal to the cell thickness of color where the area of the subpixel SG in the display pixel AG is the smallest. Then, light can be emitted from the W subpixel SG while a light component of color where the area of the subpixel SG in the display pixel AG is the smallest is emphasized, and the lack of the color in the display pixel AG can be compensated. As such, as the cell thickness of the W subpixel SG is set to be substantially equal to the cell thickness of color where the area of the subpixel SG is the smallest, white balance in white display can be set to predetermined color temperature, which makes it possible to suppress coloring in white display.

(Electronic Apparatus)

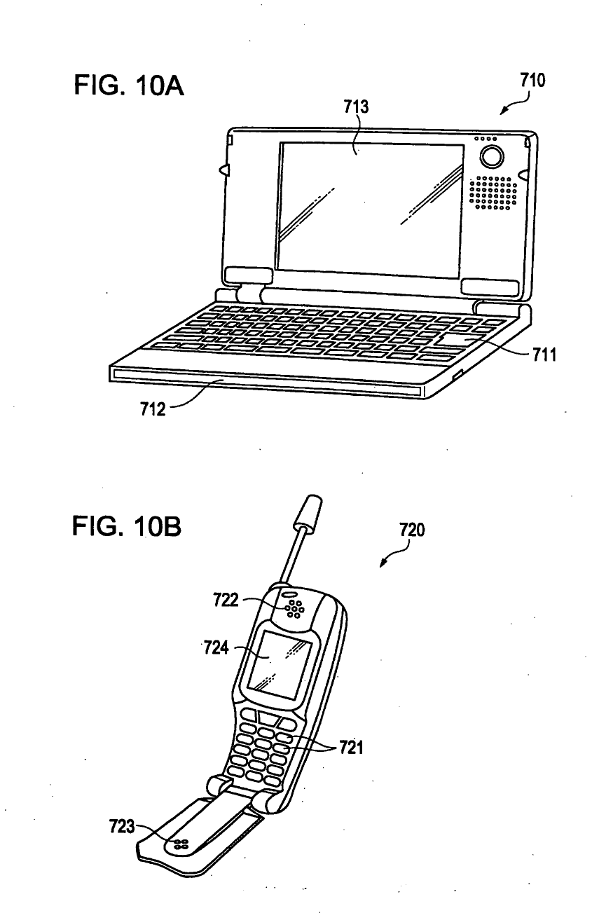

Next, an electronic apparatus to which the liquid crystal display device 100 (including the liquid crystal display device 200) can be applied will be exemplified with reference to FIG. 10.

First, an example will be described, where the liquid crystal display device 100 according to the present invention is applied to a display unit of a portable personal computer (a so-called notebook computer). FIG. 10A is a perspective view showing the construction of the personal computer. As shown in FIG. 10A, the personal computer 710 is provided with a main body section 712 having a keyboard 711 and a display unit 713 to which the liquid crystal display device 100 according to an embodiment of the invention is applied.

Continuously, another example will be described where the liquid crystal display device 100 according to the present embodiment is applied to a display unit of a mobile phone. FIG. 10B is a perspective view showing the construction of the mobile phone. As shown in FIG. 10B, the mobile phone 720 is provided with a plurality of control buttons 721, an earpiece 722, a mouthpiece 723, and a display unit 724 to which the liquid crystal display device 100 according to the present embodiment.

As an electronic apparatus to which the liquid crystal display device 100 according to the present embodiment can be applied, there are exemplified a liquid crystal television, a view finder-type or monitor-direct-view-type video tape recorder, a car navigation device, a pager, an electronic organizer, an electronic calculator, a word processor, a workstation, a video phone, a POS terminal, a digital camera and the like, in addition to the personal computer shown in FIG. 10A and the mobile phone shown in FIG. 10B.

The entire disclosure of Japanese Patent Application Nos: 2005-197073, filed Jul. 6, 2005 and 2006-163117, filed Jun. 13, 2006 are expressly incorporated by reference herein.

What is claimed is:

1. A liquid crystal display device comprising:
a pair of substrates;
a display pixel that has four R, G, B, and non-colored or white subpixels; and
a liquid crystal layer that is interposed between the pair of substrates and in which cell thicknesses in the subpixels vary,
wherein the retardation values of the R, G, and B subpixels are set in the ranges of 360 nm≦R≦700 nm, 340 nm≦G≦600 nm, and 340 nm≦B≦500 nm, respectively, and the non-colored subpixel has a cell thickness at which the display pixel becomes predetermined white balance.

2. The liquid crystal display device according to claim 1,
wherein the cell thickness of the non-colored or white subpixel is set to be substantially equal to the cell thickness of a one-color subpixel among the R, G, and B subpixels, in which the area occupied in the display pixel is the smallest.

3. The liquid crystal display device according to claim 1,
wherein the display pixel is configured such that the sum area of the non-colored or white subpixel and a one-color subpixel among the R, G, and B subpixels are substantially equal to an area of each of the other-color subpixels, and
the cell thickness of the non-colored subpixel is set to a value at which the retardation value of the one-color subpixel and the retardation value of the non-colored or white subpixel become equal to each other.

4. The liquid crystal display device according to claim 3,
wherein the display pixel is configured such that the area ratio of the R, G, B, and non-colored or white subpixels is set to 2:2:1:1, and
the cell thickness of the non-colored or white subpixel is set to be substantially equal to the cell thickness of the B subpixel.

5. The liquid crystal display device according to claim 1,
wherein the display pixel is configured such that the areas of four subpixels are substantially equal to one another, and
the cell thickness of the non-colored or white subpixel is set to a value at which the retardation value of the G subpixel and the retardation value of the non-colored or white subpixel become equal to each other.

6. The liquid crystal display device according to claim 5,
wherein the cell thickness of the non-colored or white subpixel is set to be substantially equal to the cell thickness of the G subpixel.

7. A liquid crystal display device comprising:
a pair of substrates;
a display pixel that has four R, G, B, and non-colored or white subpixels and is configured such that the area ratio of the R, G, B, and non-colored or white subpixels is set to 2:2:1:1; and
a liquid crystal layer that is interposed between the pair of substrates and in which cell thicknesses in the subpixels vary,
wherein, if the cell thicknesses are set to dr, dg, db, and dw, the R, G, B, and non-colored or white subpixels have the relationship dr≧dg≧dw=db (however, the relationship dr=dw=db is not established).

8. A liquid crystal display device comprising:
a pair of substrate;
a display pixel that has four R, G, B, and non-colored or white subpixels; and
a liquid crystal layer that is interposed between the pair of substrates and in which cell thicknesses in the subpixels vary,
wherein, if the cell thicknesses are set to dr, dg, db, and dw, the R, G, B, and non-colored or white subpixels have the relationship dr≧dw≈dg≧db (however, the relationship dr=dw=db is not established).

9. The liquid crystal display device according to claim 8,
wherein the display pixel is configured such that the area ratio of the R, G, B, and non-colored or white subpixels is set to 1:1:1:1.

10. An electronic apparatus comprising the liquid crystal display device according to claim 1 as a display unit.
